(19) United States
(12) Patent Application Publication
(10) Pub. No.: US 2008/0263804 A1
(43) Pub. Date: Oct. 30, 2008

(54) Brush storage device

(76) Inventor: Michael Stahlman, St. Clair, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/796,033

(22) Filed: Apr. 26, 2007

(51) Int. Cl. B44D 3/12

(52) U.S. Cl. 15/248.1; 206/15.3

(57) ABSTRACT

A brush storage device is shown comprising a cover with an opening located within the cover. The opening can be configured to grip a handle of a liquid media applicator brush such that the bristles of the brush are substantially immersed into a liquid media within a liquid media container when the brush storage device is installed onto the liquid media container. In alternative embodiments, the opening can include a plurality of axially aligned slits that form generally triangular shaped flexible segments that grip the handle of the brush, while in other embodiments, the opening includes a grommet that can grip the handle of the brush.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

This invention relates to a device for storage of brushes that have been used to apply liquid media to receiving surfaces, and more specifically to a device that allows the brush to be stored in a wet condition without while being capable of allowing the brush's bristles from touching the bottom of the container, thus allowing storage of the brush without cleaning the liquid media from the brush and yet still generally keeping the brush in a usable condition without the liquid media drying on the bristles of the brush.

Application of various types of liquid media to a receiving surface usually involves dipping a brush into the liquid media and then using the brush to apply the liquid media to the receiving surface. Although the application of the media is generally straightforward, the process of applying the liquid media usually takes more than one work period. That is to say, the liquid media is usually applied in more than one application period. This is particularly true in the application of some paints and polyurethane finishes. For example, when applying a light paint to a very dark surface, or vice versa, several applications of the new paint may be necessary. Application of polyurethane finishes onto woodworking surfaces can also mean application of several coats of the polyurethane to give the wooden surface the amount of protection the surface needs against abuse and moisture.

In each of the situations, there is normally a period of time in which the brush used to apply the liquid media is not being used and must be stored for later use. However, storing the brush is problematic because the liquid media within the bristles of the brush can dry on the bristles and make the brush virtually unusable at a later time. One potential solution is to insert the brush into the liquid media during the period of non-use. While this may provide a remedial solution to the drying of the bristles of the brush, such storage allows the uncovered liquid media to dry out. When the uncovered media dries, the surface of the media can harden or thicken and this can result in unusable liquid media. To prevent these problems, the brush is usually cleaned immediately after each use to remove all of the residual liquid media from the brush and the lid is replaced onto the container in which the liquid media is stored. This keeps the bristles of the brush clean, pliable, and ready for use at a later time, while at the same time keeping the liquid media fresh.

However, while cleaning the brush immediately after each use may solve part of the problem of residual dried liquid on the bristles of the brush, repetitive cleaning of the brush is time consuming and, in cases of large commercial operations, can result in significant costs. Such costs cannot be generally charged to a work project and thus result in loss of sales and profits.

### SUMMARY OF THE INVENTION

In accordance with embodiments of the present invention, a unique brush storage device is disclosed that reduces the need to clean a brush after each use while still generally allowing the brush to be used at a later time without significant compromise to the bristles of the brush. Additionally, embodiments of the present invention also allow for the closure of the liquid media container while at the same time storing the brush without cleaning.

### DESCRIPTION OF THE DRAWINGS

In the accompanying drawings which form part of the specification:

FIG. 1 shows a perspective view of one embodiment of the present invention.

FIG. 2 shows a plan view of one embodiment of the present invention.

FIG. 3 shows a vertical section view of one embodiment of the present invention.

FIG. 4 shows a perspective view of one alternate embodiment of the present invention.

FIG. 5 shows a plan view of one alternate embodiment of the present invention.

FIG. 6 shows a vertical section view of one alternate embodiment of the present invention.

Corresponding reference numerals indicate corresponding steps or parts throughout the several figures of the drawings.

While one embodiment of the present invention is illustrated in the above referenced drawings and in the following description, it is understood that the embodiments shown are merely examples of preferred embodiments offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE EMBODIMENT OF THE INVENTION

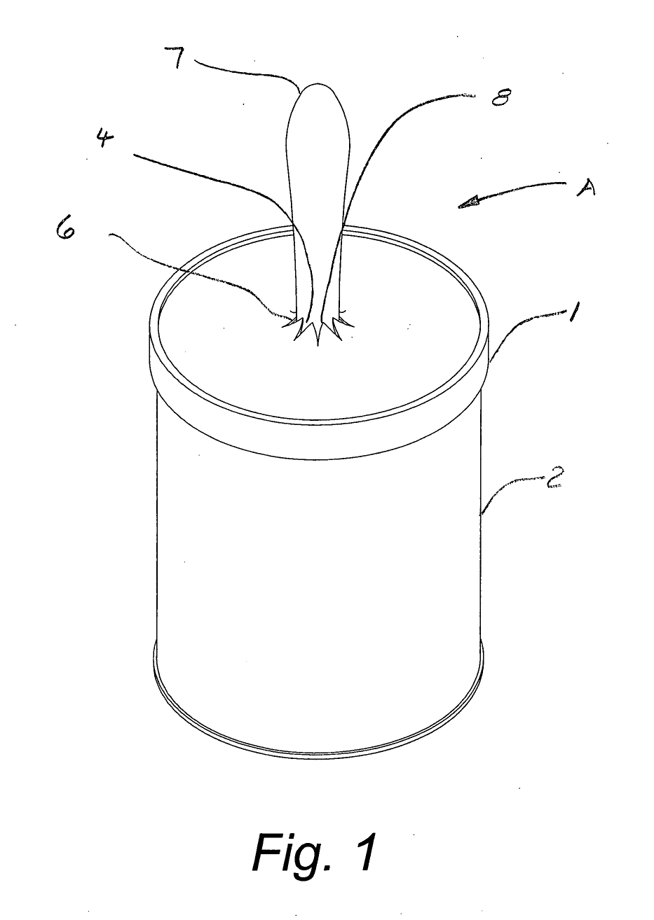

One preferred embodiment of the present invention is illustrated in FIG. 1. In this embodiment, a brush storage device A is shown. The brush storage device A comprises a cover 1 that is sized, shaped, and configured to fit onto a standard one gallon container of liquid media. It is understood that the liquid media can be any liquid that can be applied with a bristled brush and can include, for example, liquid media such as paint, varnish, and other types of finishes. It will also be appreciated by those skilled in the art that while the present embodiment is sized, shaped, and configured to fit onto a one gallon container of liquid media, the brush storage device can be adapted to fit all other sizes of containers of liquid and still remain within the scope and intent of the present invention.

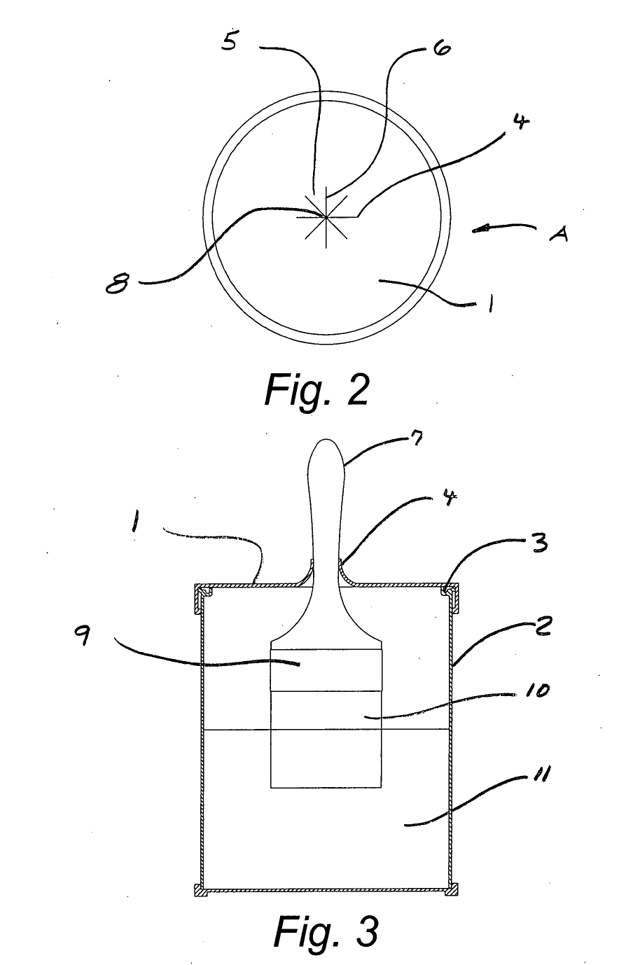

In FIG. 3, a vertical section through one embodiment of the present invention shows how the cover 1 can be configured to fit onto a standard metallic liquid media container 2. The standard liquid media container 2 of this embodiment includes an upper lip portion 3 that generally accepts a mating metallic lid (not shown) to be installed onto the upper lip portion. In this embodiment, the cover 1 can be manufactured from a plastic material that can be sized and dimensioned to allow the cover 1 to provide a substantially sealed fit between the cover and the liquid media container 2.

It is noted that while many liquid media containers 2 are constructed of metallic material and have a metallic mating lid, other versions of the liquid media container 2 are made from other materials and have different styles of mating lids. For example, some liquid media containers 2 are made of plastic material and include plastic lids having internal threads that mate with matching external threads on the top of the liquid media container. In that embodiment, the liquid media container 2 is sealed by screwing the matching lid onto the top of the liquid media container. In light of these various types of liquid media containers 2, it will be appreciated the brush storage device A can be readily adapted to mate with the top of any liquid media container 2 and still remain within the scope and intent of the present invention. For example, in the case where a plastic liquid media container 2 is used, the brush storage device A can be manufactured to include a set of internal threads that are sized and configured to match the set of external threads of the plastic liquid media container 2. It is understood that the brush storage device A can be adapted to yet other types of liquid media containers 2 and remain within the scope of the present invention.

The brush storage device A in the embodiment shown in FIG. 1, FIG. 2, and FIG. 3 includes an opening 4 having a gripping portion 8 into which a handle 7 of a brush 9 can be installed. The gripping portion 8 of the present embodiment comprises a plurality of segments 5 that are in the general shape of pointed teeth-like projections wherein each segment 5 comprises two edges 6 and a point 8. Each of the segments 5 can be formed from the material used to manufacture the brush storage device A, and in fact, can be integral with the brush storage device. In that embodiment, the segments 5 can be formed by placing a plurality of slits in the brush storage device A such that plurality of slits is in the general arrangement of an asterisk. In the embodiment shown in FIGS. 1, 2, and 3, there are eight segments 5, however, any number of segments can be included as long as the number of segments included are sufficient to grip the handle. Additionally, while the present embodiment discloses generally pointed teeth-like segments 5, other shaped segments can also be used as long as the shape of the segments allows the segment to sufficiently grip the handle 7 to prevent the handle from sliding within the brush storage device A when the brush 9 has been stored in the brush storage device. Also, while it is understood that the plurality of segments 5 in the present embodiment are generally flexible, other embodiments of the present invention could incorporate less flexible segments or more flexible and still remain within the intended scope of the present invention.

In operation, the present embodiment of the brush storage device A is used to replace the lid that accompanied the liquid media container 2 before the liquid storage container is first opened for use. That lid can be set aside and replaced by the brush storage device A to cover the liquid media container 2 when no liquid media 11 is being removed from the container. The shape and size of each of the plurality of segments 5 is such as to keep the opening 4 substantially closed.

When the user of the brush 9 must halt a liquid media application session, the user inserts the handle 7 into the gripping portion of the opening 4 of the brush storage device A and pushes the handle 7 of the brush 9 through gripping portion of the opening 4 until the bristles 10 of the brush 9 are in relation with the brush storage device A such that when the brush storage device A is installed onto the liquid media container 2, the bristles 10 are sufficiently immersed into the liquid media 11. When positioned in that manner, the shape and configuration of the plurality of segments 5 are such that the plurality of segments 5 prevent the handle 7 of the brush 9 from lowering into the liquid media 11 when the brush storage device A is installed onto the liquid media container 2. When the brush 9 is stored in this manner, the bristles 10 of the brush 9 remain moist as a result of the immersion of the bristles into the liquid media 11.

When the user starts a new session of applying the liquid media 11 to a receiving surface, the user removes the brush storage device A from the top of the liquid media container 2. The user can then remove the brush 9 from the brush storage device A by sliding the handle 7 of the brush 9 through the opening 4 of the brush storage device A until the handle 7 is clear of the gripping portion of the opening 4. If the user is still not able to complete the application of the liquid media in a second session, the user stores and retrieves the brush 9 as described above until such time as there is no further need to use the brush to apply the liquid media 11. The brush 9 is then cleaned and stored elsewhere and either the brush storage device A or the lid originally furnished with the liquid media container 2 are installed onto the liquid media container to preserve the remnants of the liquid media 11 in the liquid media container.

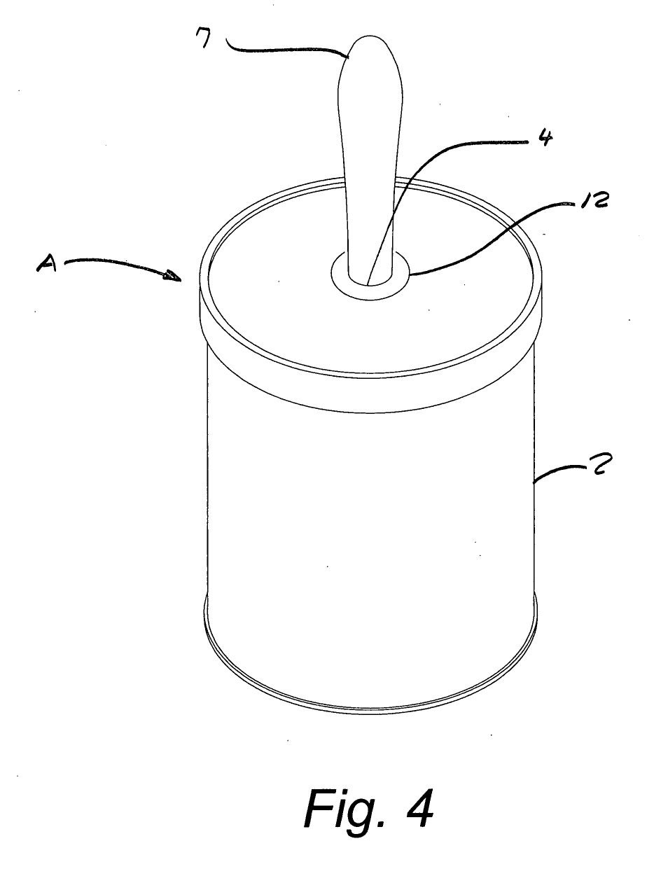

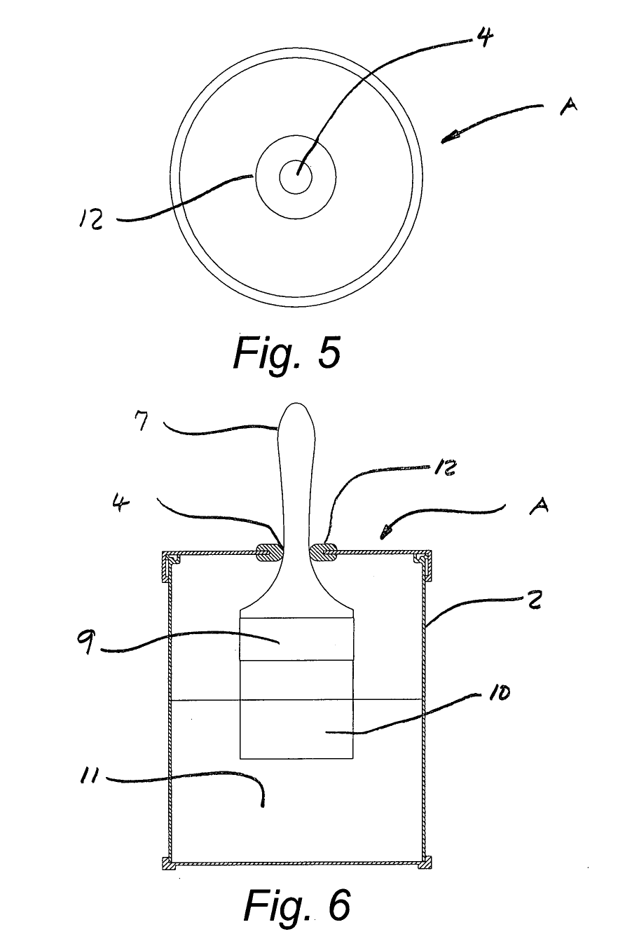

An alternative embodiment of the present invention is shown in FIGS. 4, 5, and 6. In that embodiment, the plurality of segments 5 is replaced with a grommet 12 that has been installed within an opening 13 within the brush storage device A. The grommet 12 is sized to provide sufficient grip of the handle 7 of the brush 9 to inhibit the brush from sliding into the liquid media 11 when the brush storage device A is installed onto the liquid media container 2. All other functions and descriptions for this alternative embodiment are generally as described in the first embodiment disclosed above.

It will be appreciated by those skilled in the art that other methods may be used to suspend the brush within the container. In fact, any method can be used to suspend the brush as long as the method used is capable of suspending the brush within the container as described herein.

While the above written description describes various embodiments of the present invention, it will be clear that the present invention may be otherwise easily adapted to fit any configuration where a brush storage device is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A liquid media applicator brush storage device comprising:
a cover configured to be substantially sealable with an opening of a liquid media container; and
a gripping portion located in the cover wherein the gripping device is configured to slideably grip a handle of a liquid media applicator brush such that when the cover is disposed on a top of the liquid media container the liquid media applicator brush is capable of being at least partially immersed in a liquid media disposed within the liquid media container.

2. The liquid media applicator brush storage device of claim 1 wherein the gripping portion is sufficiently flexible to allow the handle of the liquid media applicator brush to be inserted into and removed from the gripping portion without damage to the liquid media applicator brush.

3. The liquid media applicator brush storage device of claim 2 wherein the gripping portion comprises a plurality of segments.

4. The brush storage device of claim 3 wherein each of the plurality of segments are generally in the shape of pointed teeth-like projections.

5. The liquid media applicator brush storage device of claim 4 wherein the plurality of segments are arranged in the general form of an asterisk and are located substantially in the axial center of the cover.

6. The liquid media applicator brush storage device of claim 5 wherein there are eight segments in the gripping portion.

7. The liquid media applicator brush storage device of claim 6 wherein cover is configured to allow a friction fit with an upper opening of a standard metallic liquid media container that is at least one of either a one gallon size liquid media container or a five gallon size liquid media container.

8. The liquid media applicator brush storage device of claim 6 wherein the cover is configured to allow a threaded fit with an upper opening of a standard plastic-based liquid media container that is at least one of either a one gallon size liquid media container or a five gallon size liquid media container.

9. The liquid media applicator brush storage device of claim 8 wherein the cover comprises a set of internal threads sized and configured to match the external threads of a plastic-based liquid media container to allow a threaded fit with an upper opening of the standard plastic-based liquid media container and wherein the standard plastic-based liquid media container is at least one of either a one gallon size liquid media container or a five gallon size liquid media container.

10. The liquid media applicator brush storage device of claim 2 wherein the gripping portion includes a grommet installed within an opening of the cover.

11. The liquid media applicator brush storage device of claim 10 wherein the grommet is sized to provide sufficient grip the handle of the liquid media applicator brush to inhibit the brush from sliding into the liquid media when the brush storage device is installed onto the liquid media container.

12. A liquid media applicator brush storage device comprising:
means for attaching a cover onto an opening of a liquid media container; and
means for slideably gripping a handle of a liquid media applicator brush such that when the cover is disposed on a top of the liquid media container the liquid media applicator brush is capable of being at least partially immersed in a liquid media disposed within the liquid media container.

13. The liquid media applicator brush storage device of claim 12 wherein the means for gripping a handle of a liquid media applicator brush is sufficiently flexible to allow the handle of the liquid media applicator brush to be inserted into and removed from the gripping portion without damage to the liquid media applicator brush.

14. The liquid media applicator brush storage device of claim 13 wherein the means for gripping a handle of a liquid media applicator brush comprises a plurality of segments.

15. The liquid media applicator brush storage device of claim 14 wherein each of the plurality of segments are generally in the shape of pointed teeth-like projections.

16. The liquid media applicator brush storage device of claim 15 wherein the plurality of segments are arranged in the general form of an asterisk and are located substantially in the axial center of the cover.

17. The liquid media applicator brush storage device of claim 16 wherein there are eight segments in the gripping portion.

18. The liquid media applicator brush storage device of claim 13 wherein means for attaching a cover onto an opening of a liquid media container includes providing a cover that is configured to allow a friction fit with an upper opening of a standard metallic paint can that is at least one of either a one gallon size liquid media container or a five gallon size liquid media container.

19. The liquid media applicator brush storage device of claim 13 wherein means for attaching a cover onto an opening of a liquid media container includes providing a cover that is configured to allow a threaded fit with an upper opening of a standard plastic-based liquid media container that is at least one of either a one gallon size liquid media container or a five gallon size liquid media container.

20. The liquid media applicator brush storage device of claim 13 wherein the means for gripping a handle of a liquid media applicator brush comprises a grommet installed within an opening of the cover wherein the grommet is sized to provide sufficient grip the handle of the liquid media applicator brush to inhibit the brush from sliding into the liquid media when the brush storage device is installed onto the liquid media container.
